(19) United States
(12) Patent Application Publication
(10) Pub. No.: US 2014/0226572 A1
(43) Pub. Date: Aug. 14, 2014

(54) Smart WiFi Access Point That Selects The Best Channel For WiFi Clients Having Multi-Radio Co-Existence Problems

(71) Applicant: QUALCOMM INCORPORATED, San Diego, CA (US)

(72) Inventors: Sudheep K. Thota, San Diego, CA (US); Jason Hou, Millbrae, CA (US); Yoseph Malkin, Palo Alto, CA (US)

(73) Assignee: QUALCOMM Incorporated, San Diego, CA (US)

(21) Appl. No.: 13/766,700

(22) Filed: Feb. 13, 2013

(51) Int. Cl. H04W 72/08

(52) U.S. Cl. CPC H04W 72/082
USPC 370/329

(57) ABSTRACT

A wireless access point (AP) stores a region code that identifies a country/region in which the wireless AP is designed to operate. This region code can be provided by the wireless AP vendor, or in response to information provided by the wireless AP user or a GPS receiver. In response to the region code, the wireless AP identifies one or more WiFi channels that are subject to interference within the region due to the non-WiFi wireless communication channels that are approved for use within the region. The wireless AP then selects a WiFi channel for wireless communication, wherein the wireless AP avoids selecting the WiFi channels identified as being subject to interference within the region.

### FIELD OF THE INVENTION

The present invention relates to wireless access points (AP) for use in a wireless communication system (including WiFi). More specifically, the present invention relates to structures and methods for operating wireless APs such that interference from non-WiFi (e.g., BLUETOOTH® (Bluetooth) and cellular) radios is minimized.

### RELATED ART

FIG. 1 is a block diagram of a wireless communication system, including a conventional wireless local area network (WLAN) 100, which is configured to operate in accordance with an IEEE 802.11 communication protocol (WiFi). WLAN 100 includes wireless access point (AP) 101, which communicates with multiple WiFi stations (STAs) 111₁-111_{N}, in a manner known to those of ordinary skill in the art. WiFi stations (STAs) 111₁-111_{N} are implemented within corresponding wireless devices 110₁-110_{N}. Wireless AP 101 selects a WiFi channel 105 (i.e., a WiFi frequency band), wherein a WiFi radio 102 with AP 101 communicates with WiFi radios 112₁-112_{N} of the WiFi STAs 111₁-111_{N} using the selected WiFi channel 105. Depending on the IEEE 802.11 protocol implemented by wireless AP 101, the WiFi channel 105 will exist within the 2G or 5G frequency bands.

Any wireless device acting as a WiFi STA may include multiple radios. For example, wireless device 110₁ may be a smartphone that includes a Bluetooth radio 113, which enables wireless communication with an external Bluetooth device 123, and a cellular radio 114, which enables wireless communication on a cellular network 124. Harmonics and other impairments introduced by radios 113-114 may directly affect certain frequencies/channels in the WiFi 2G and 5G bands. For example, suppose that wireless AP 101 selects WiFi channel 105 to correspond with channel 13 of the 2G WiFi frequency band, which has a channel center frequency of 2.472 GHz. Further suppose that cellular radio 114 communicates with cellular network 124 on the GSM850 cellular band, which uses a 824.2 MHz channel, and exhibits a third harmonic frequency of 2472.6 MHz (i.e., 824.2 MHz×3). This third harmonic frequency of cellular radio 114 will result in interference in 2G WiFi channel 13. This interference may result in sensitivity loss within the local WiFi radio 112₁, thereby degrading the performance of WLAN network 100.

Wireless AP 101 attempts to detect interference on the wireless medium, and select the frequency band of the WiFi channel 105 in response to the detected interference, whereby frequency bands that experience interference are avoided. However, the interference introduced by radios 113-114 may not be large enough to be detected at wireless AP 101, because of the distance that exists between wireless AP 101 and the corresponding wireless device 110₁. That is, the strength of the interfering signals of the radios 113-114 may only be significant near the wireless device 110₁, because of the proximity between the WiFi radio 112₁ and the radios 113-114 (as all these radios 112₁ and 113-114 are located on the same wireless device 110₁). As a result, the signal strength of the interference introduced by radios 113-114 may be high enough to interfere with the closely situated WiFi radio 112₁, thereby resulting in the above-described performance degradation, but not high enough to be detected (and avoided) by wireless AP 101.

Moreover, WiFi STAs 111₁-111_{N} are not capable of changing the selected WiFi channel 105 (or preventing wireless AP 101 from selecting the WiFi channel 105 to exist in a frequency band known by the WiFi STAs 111₁-111_{N} to be experiencing interference), because the selected WiFi channel 105 is controlled by wireless AP 101.

It would therefore be desirable at least to have a method and/or apparatus that enables a wireless AP to select a WiFi channel for communicating with WiFi STAs, wherein the selected WiFi channel is not subject to interference from non-WiFi radios located on the same wireless devices as the WiFi STAs.

### SUMMARY

Accordingly, the present invention provides a wireless access point (AP) that stores a region code that identifies a country/region in which the wireless AP is designed to operate. This region code can be stored on the wireless AP by the AP vendor, prior to sale of the wireless AP. Alternately, the region code can be determined in response to information input by a user during setup of the wireless AP. In another embodiment, the region code is determined in response to location information provided by a global positioning system (GPS) receiver on the wireless AP. In yet another embodiment, the region code may be determined in response to location information provided by a GPS receiver on a wireless device (e.g., smartphone) in wireless communication with the wireless AP.

In response to the region code, the wireless AP identifies one or more WiFi channels that are subject to interference within the region due to non-WiFi wireless communication channels that are approved for use within the region. The wireless AP then selects a WiFi channel for wireless communication, wherein the wireless AP avoids selecting the WiFi channels identified as being subject to interference within the region.

In one embodiment, a lookup structure is used to identify the WiFi channels that are subject to interference in response to the region code. For example, a first lookup table may provide a list of non-WiFi wireless communication channels (e.g., Bluetooth and cellular channels) that are approved for use within the region in response to the region code, and a second lookup table may provide a list of the WiFi channels subject to interference within the region in response to the list of non-WiFi wireless communication channels approved for use within the region. The contents of the lookup structure can be updated to reflect changes in the list of non-WiFi wireless communication channels approved for use within the region.

The present invention will be more fully understood in view of the following description and drawings.

### BRIEF DESCRIPTION OF THE DRAWINGS

FIG. 1 is a block diagram of a conventional wireless local area network (WLAN), including a wireless device that includes a WiFi radio for implementing a WiFi station and additional radios that introduce interference to the WiFi radio.

FIG. 2 is a block diagram of a wireless communication system that includes a WLAN that avoids selecting WiFi channels that are subject to interference within a specified region, in accordance with one embodiment of the present invention.

FIG. 3 is a block diagram of a channel lookup table (LUT) and an interference LUT of the WLAN of FIG. 2, which are used to identify WiFi channels that are subject to interference in response to a region code, in accordance with one embodiment of the present invention.

FIG. 4 is a flow diagram illustrating a process implemented by a wireless AP in accordance with one embodiment of the present invention.

FIG. 5 is a block diagram of the wireless communication system of FIG. 2, modified to include several additional structures for specifying a region code in accordance with alternate embodiments of the present invention.

### DETAILED DESCRIPTION

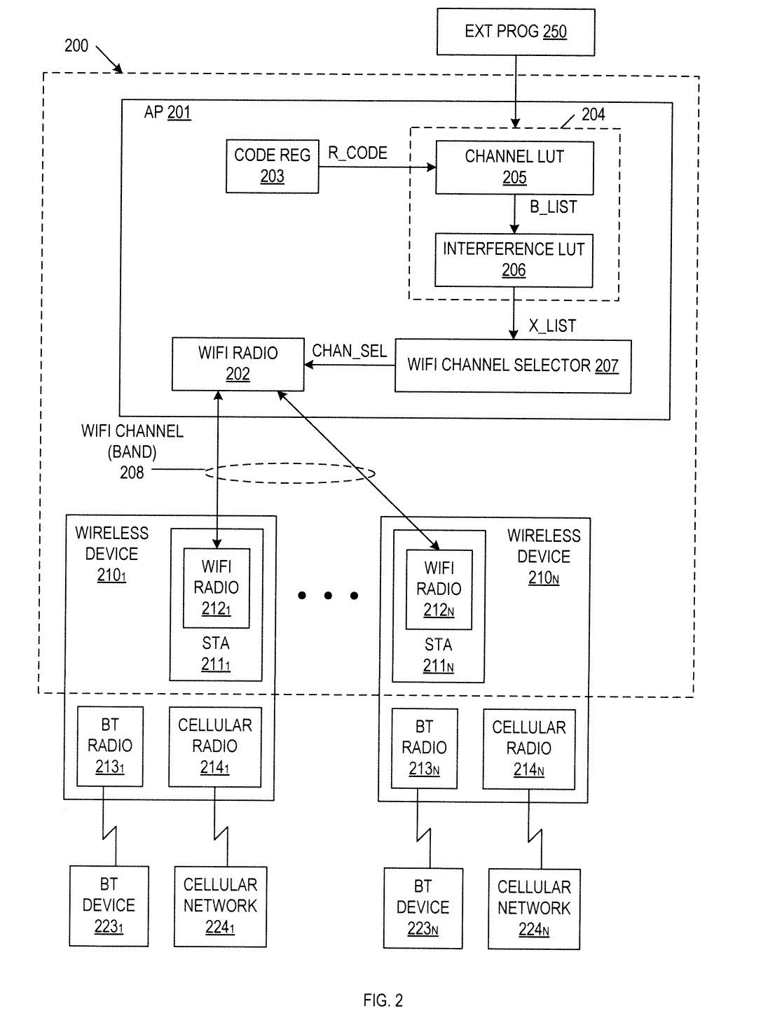

FIG. 2 is a block diagram of a wireless communication system that includes WLAN 200 in accordance with one embodiment of the present invention. WLAN 200 includes wireless (WiFi) access point (AP) 201, and WiFi stations (STAs) 211₁-211_{N}, which are implemented within wireless devices 210₁-210_{N}, respectively. Wireless devices 210₁-210_{N} may be smartphones, or other similar devices. WiFi STAs 211₁-211_{N} include WiFi radios 212₁-212_{N}, respectively, which communicate with a WiFi radio 202 in wireless AP 201 over a selected WiFi channel 208.

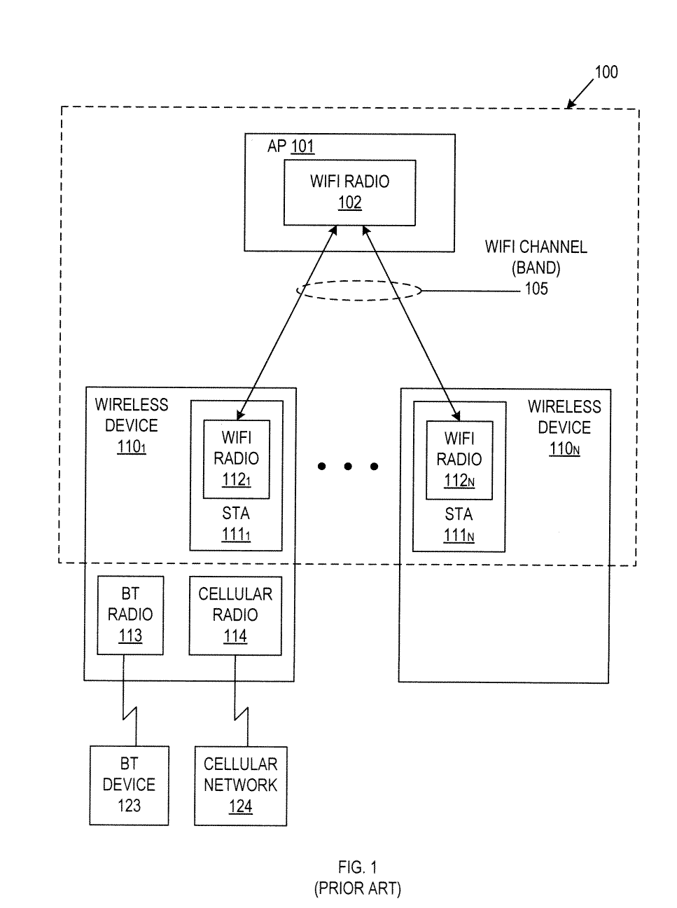

Wireless devices 210₁-210_{N} include radios in addition to WiFi radios 212₁-212_{N} (i.e., non-WiFi radios). For example, wireless devices 210₁-210_{N} include Bluetooth radios 213₁-213_{N}, respectively, and cellular radios 214₁-214_{N}, respectively. Bluetooth radios 213₁-213_{N} communicate with external Bluetooth devices 223₁-223_{N}, respectively, using wireless (Bluetooth) communication channels/bands. Similarly, cellular radios 214₁-214_{N}, communicate with cellular networks 224₁-224_{N}, respectively, using wireless (cellular) communication channels/bands. Although Bluetooth and cellular radios are described in the present example, it is understood that other types of non-WiFi radios may be located on wireless devices 210₁-210_{N} in other embodiments of the present invention. Signals transmitted by Bluetooth radios 213₁-213_{N} and cellular radios 214₁-214_{N} may result in interference with signals transmitted on WiFi channel 208, due to the frequencies implemented by the various radios. One example of such interference has been described above in connection with the WLAN 100 of FIG. 1.

Wireless AP 201 stores information that identifies the country (or region) where the wireless AP 201 is designed to operate. In one embodiment, wireless AP 201 includes a region code register 203 that stores a region code (R_CODE) that identifies the country/region where the wireless AP 201 will be sold and used. Different countries/regions have different regulatory bodies that impose different regulatory limitations on WiFi systems that operate in these countries/regions (e.g., WiFi systems in the U.S. are regulated by the Federal Communications Commission (FCC)). Thus, the region code R_CODE identifies the regulatory domain in which the wireless AP 201 operates.

In accordance with one embodiment of the present invention, the region code R_CODE is provided to lookup structure 204. As described in more detail below, lookup structure 204 provides a list (X_LIST) of one or more WiFi channels that are subject to interference in response to the region code R_CODE. In general, the list X_LIST of WiFi channels that are subject to interference are determined in view of the non-WiFi wireless communication channels/bands that are approved for use in the country/region specified by the region code R_CODE.

The list X_LIST of WiFi channels that are subject to interference is provided to WiFi channel selector 207, which selects the WiFi channel 208 to be used by the WiFi radio 202 of wireless AP 201. In one embodiment, WiFi channel selector 207 simply does not use any of the WiFi channels specified by the list X_LIST when selecting the WiFi channel 208 to be used by WiFi radio 202. In an alternate embodiment, WiFi channel selector 207 will only use WiFi channels specified by the list X_LIST after determining that the remaining WiFi channels (i.e., WiFi channels not specified by the list X_LIST) are actually experiencing interference on the wireless medium. Note when selecting the WiFi channel 208 to be used by wireless AP 201, WiFi channel selector 207 takes into account conventional conditions and parameters, in addition to the list, X_LIST. These conditions and parameters are known to those of ordinary skill in the art, and are not described herein.

Upon determining which WiFi channel should be used by wireless AP 201, WiFi channel selector 207 transmits a channel selection value (CHAN_SEL) to WiFi radio 202, wherein the channel selection value CHAN_SEL causes the WiFi radio 202 to use the determined channel as WiFi channel 208.

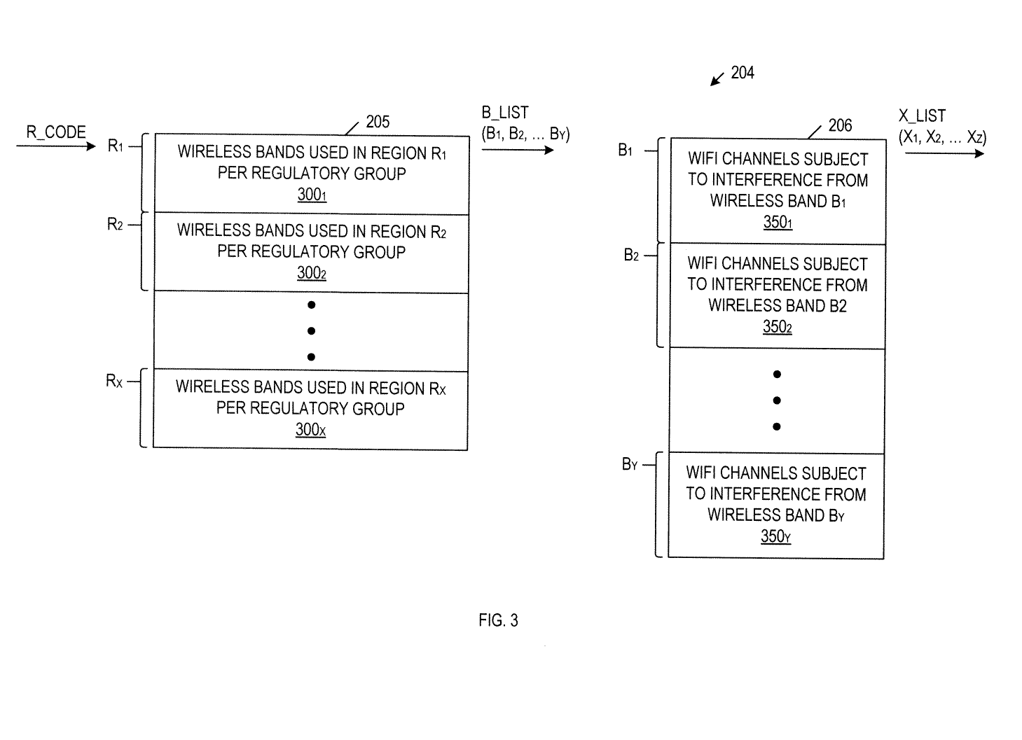

In one embodiment of the present invention, lookup structure 204 includes a channel lookup table (LUT) 205 and an interference LUT 206. FIG. 3 is a block diagram illustrating channel LUT 205 and interference LUT 206 in more detail, in accordance with one embodiment of the present invention.

The region code value R_CODE has a value of R₁, R₂, . . . or R_{X}, depending on the country/region specified by the region code R_CODE. For example, a region code R_CODE of R₁ may indicate that the wireless AP 201 is designed to be used in the United States. The region codes R_CODE (e.g., R₁, R₂, . . . R_{X}) are used to access corresponding entries (e.g., 300₁, 300₂, . . . 300_{X}, respectively) of channel LUT 205, wherein each of these corresponding entries identifies the non-WiFi wireless frequency bands approved for use by the regulatory domains of the associated countries/regions. For example, the region code value of R₁ accesses corresponding entry 300₁ of channel LUT 205, wherein entry 300₁ identifies the non-WiFi wireless frequency bands (e.g., Bluetooth and cellular frequency bands) approved by the FCC for wireless communication in the United States.

In the described embodiment, each of the wireless frequency bands is identified by a corresponding band value, wherein the possible band values are represented as B₁, B₂, . . . B_{Y}. Thus, each of the entries 300₁-300_{X} of channel LUT 205 includes one or more of the band values B₁-B_{Y}, such that each of the entries 300₁-300_{X} includes a list (B_LIST) of the band values that correspond with the non-WiFi wireless frequency bands approved for wireless communication in the associated country/region. For example, the band value B₁ may correspond with the GSM850 cellular band, such that the presence of the band value B₁ in entry 300₁ indicates that the GSM850 cellular band is an approved wireless communication band within the United States.

The band list B_LIST retrieved from channel lookup table 205 in response to the region code R_CODE is provided to interference LUT 206. The band values of the retrieved band list B_LIST (e.g., B₁, B₂, . . . B_{Y}) are used to access corresponding entries (e.g., 350₁, 350₂, . . . 350_{Y}, respectively) of interference LUT 206, wherein each of these corresponding entries identifies the WiFi channels, if any, that are subject to interference from signals transmitted in the non-WiFi wireless communication channels identified by the band values of the band list B_LIST. For example, the band value B₁ is used to access corresponding entry 350₁ of interference LUT 206, wherein this entry 350₁ identifies the 2G WiFi channel 13 as a WiFi channel that is subject to interference in response to operation of the GSM850 frequency band.

In the described embodiment, each WiFi channel is identified by a corresponding WiFi channel value within interference LUT 206, wherein the possible WiFi channels are identified by WiFi channel values X₁, X₂, . . . X_{Z}. Each of the entries 350₁-350_{Y} of interference LUT 206 may include any number of WiFi channel values, depending on the interference (if any) associated with the corresponding wireless communication band. Note that interference LUT 206 is accessed for each of the band values in the received band list, B_LIST. Thus, a plurality of WiFi channels may be subject to interference from the various bands identified by the received band list B_LIST. All of the WiFi channel values retrieved from interference LUT 206 in response to the received band list B_LIST are provided to WiFi channel selector 207 (FIG. 2) as the list, X_LIST. As described above, WiFi channel selector 207 selects the WiFi channel to be used by WiFi radio 202 in response to the received list X_LIST (e.g., by not selecting a WiFi channel identified by the received list, X_LIST).

Note that the above-described embodiment causes WiFi channel selector 207 to avoid any WiFi channels that may be potentially subject to interference in the associated country/region. Thus, in the example described above, WiFi channel selector 207 will not select 2G WiFi channel 13 in view of the fact that the GSM850 cellular band is approved for use in the United States, even though it is possible that none of the wireless devices 210₁-210_{N} engaged in WiFi communications with wireless AP 201 is actually using the GSM850 cellular band.

Although lookup structure 204 has been described in connection with the use of two LUTs 205-206, it is understood that the lookup structure 204 could be implemented in various other ways in other embodiments of the present invention. In one such alternate embodiment, the interference channel list X_LIST is provided by a single look-up table in response to the region code value R_CODE.

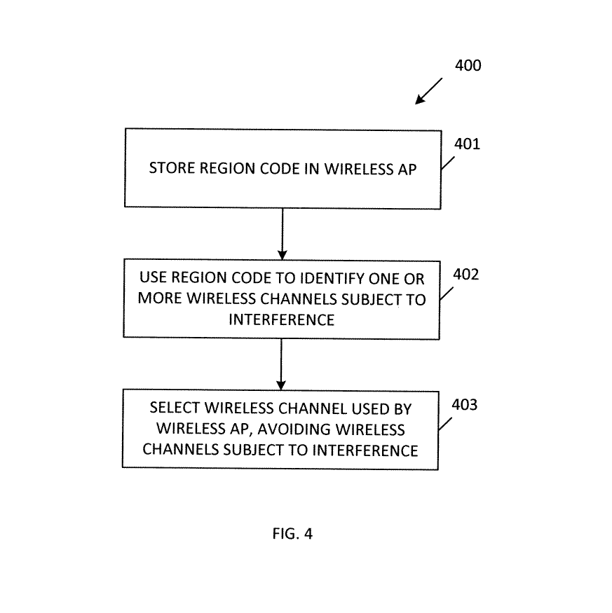

FIG. 4 is a flow diagram 400 illustrating a process implemented by wireless AP 201 in accordance with one embodiment of the present invention. As described above, a region code R_CODE is initially stored in the code register 203 of wireless AP 201 (Step 401). The region code R_CODE is then used (e.g., by the lookup structure 204) to identify one or more wireless channels that are subject to interference within the region identified by the region code R_CODE (Step 402). The wireless AP 201 then selects a wireless channel on which to communicate (e.g., using the channel selector 207), wherein the wireless AP 201 avoids selecting the identified wireless channel(s) that are subject to interference within the region (Step 403).

In accordance with one embodiment, the region code R_CODE stored by the code register 203 of the wireless AP 201 is specified by the vendor prior to sale of the wireless AP 201 (e.g., during manufacture). The wireless AP 201 is only sold (and specified for operation) in the associated country/region. Note that in one variation, the lookup structure 204 may be simplified to only include entries associated with the country/region specified by the region code R_CODE.

In accordance with another embodiment of the present invention, the contents of channel LUT 205 and interference LUT 206 are dynamically updated via an external programming interface 250 (e.g., via the Internet) if the non-WiFi wireless communication bands approved for use within a particular country/region (and/or the WiFi channels subject to interference) change after sale of the wireless AP 201.

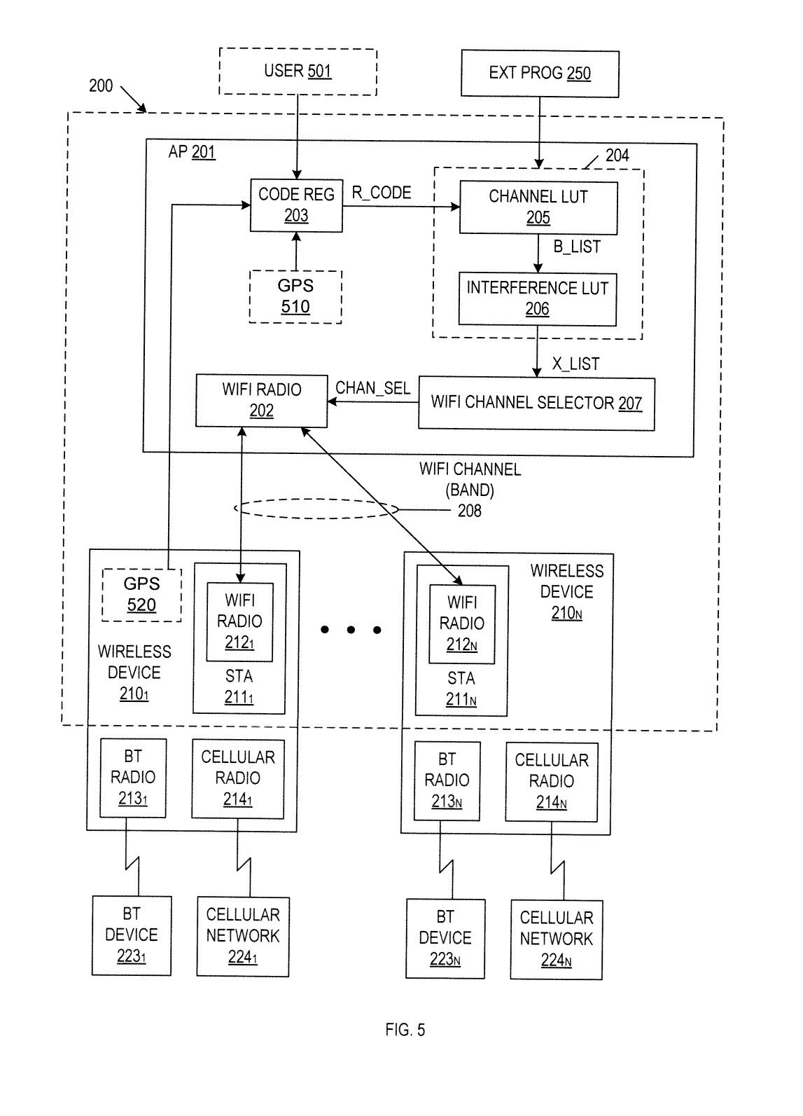

Although the embodiments described above implement a region code R_CODE that is specified by the vendor prior to sale of the wireless AP, it is understood that the region code R_CODE may be specified in other manners in other embodiments of the present invention. FIG. 5 is a block diagram of the WLAN 200, which is modified to include several additional structures that can be used to specify the region code R_CODE in accordance with other embodiments of the present invention. More specifically, WLAN system 200 can be modified to include user interface 501, global positioning system (GPS) receiver 510 and/or GPS receiver 520.

User interface 501 allows a user of wireless AP 201 to specify the region code R_CODE to be stored in region code register 203. During the initialization/setup of wireless AP 201, the user of wireless AP 201 is prompted via user interface 501 to enter information identifying the country/region in which the wireless AP 201 is being used. This user-entered information is used to select the region code R_CODE corresponding with the identified country/region. The selected region code R_CODE is written to code register 203, and is used to identify the WiFi channels subject to interference in the manner described above.

Allowing the user to enter the region code R_CODE in the above-described manner can be particularly useful in regulatory regions that include multiple countries. For example, some wireless APs are designated for sale and use in Europe, such that these wireless APs can be used in any of the European countries. In this case, the vendor designated region code, is really a ‘region’ code (which specifies Europe). However, different countries in Europe may use different wireless communication bands. Allowing the user to specify the actual country in which the wireless AP 201 is operating will allow the wireless AP 201 to more accurately identify WiFi channels that are subject to interference in the actual country of use. Note that in this example, each of the countries of Europe would have a corresponding region code R_CODE and corresponding sets of entries within the lookup structure 204.

In another embodiment, GPS receiver 510 is included within wireless AP 201. In this embodiment, GPS receiver 510 determines the location of the wireless AP 201 in a manner known to those of ordinary skill in the art, and in response, enters a region code R_CODE corresponding to the determined location into code register 203.

In accordance with yet another embodiment, a GPS receiver 520 included within wireless device 210₁ determines the location of wireless device 210₁. Wireless device 210₁ transmits this determined location to wireless AP 201 (e.g., from WiFi radio 212₁ to WiFi radio 202, via WiFi channel 208). In response, wireless AP 201 enters a region code R_CODE corresponding to the determined location of the wireless device 210₁ into code register 203.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

We claim:

1. A method comprising:
storing a region code in a wireless access point, wherein the region code identifies a region in which the wireless access point operates;
using the region code to identify a one or more wireless channels that are subject to interference within the region; and
selecting a wireless channel used by the wireless access point, wherein the wireless channel is selected to avoid the one or more wireless channels that are subject to interference within the region.

2. The method of claim 1, wherein using the region code to identify one or more wireless channels that are subject to interference within the region comprises identifying one or more cellular radio bands used for wireless communication within the region in response to the region code.

3. The method of claim 2, wherein identifying the one or more wireless channels that are subject to interference within the region is in response to identifying the one or more cellular radio bands.

4. The method of claim 1, further comprising determining the region code using a global positioning system (GPS) data available to the wireless access point.

5. The method of claim 4, further comprising receiving the GPS data from a GPS receiver of an external wireless device.

6. The method of claim 4, further comprising receiving the GPS data from a GPS receiver of the wireless access point.

7. The method of claim 1, further comprising receiving the region code through a user interface of the wireless access point.

8. The method of claim 1, further comprising storing a cellular band information in the wireless access point, wherein the cellular band information identifies one or more cellular bands used within the region.

9. The method of claim 8, further comprising storing a wireless channel interference information in the wireless access point, wherein the wireless channel interference information identifies one or more wireless channels that experience interference in response to transmissions in the one or more cellular bands.

10. The method of claim 1, wherein the region code identifies a country in which the wireless access point operates.

11. The method of claim 1, wherein using the region code to identify the one or more wireless channels that are subject to interference within the region comprises identifying a group of wireless channels approved for use within the region in response to the region code.

12. The method of claim 11, wherein using the region code to identify the one or more wireless channels that are subject to interference within the region further comprises identifying the one or more wireless channels that are subject to interference within the region in response to the group of wireless channels approved for use within the region.

13. The method of claim 1, wherein identifying the one or more wireless channels that are subject to interference within the region comprises identifying a one or more WiFi channels.

14. A wireless access point comprising:
a memory to store a region code that identifies a region in which the wireless access point operates;
a lookup structure coupled to the memory, wherein the lookup structure to provide a list identifying a one or more wireless channels subject to interference within the region in response to the region code; and
a channel selector coupled to the lookup structure, wherein the channel selector to select a wireless channel used by the wireless access point for wireless communications, wherein in selecting the wireless channel, the channel selector to avoid selecting the one or more wireless channels identified by the list.

15. The wireless access point of claim 14, further comprising a user interface to receive the region code from a user of the wireless access point.

16. The wireless access point of claim 14, further comprising a global positioning system (GPS) receiver to determine a location of the wireless access point, and the region code.

17. The wireless access point of claim 14, wherein the one or more wireless channels of the list include a one or more WiFi channels.

18. The wireless access point of claim 14, wherein the lookup structure comprises:
a first lookup table to provide a band list identifying a one or more wireless channels approved for use within the region in response to the region code; and
a second lookup table to provide the list of the one or more wireless channels subject to interference within the region in response to the band list.

19. The wireless access point of claim 14, wherein the lookup structure is programmable to reflect changes in the band list of the one or more wireless channels approved for use within the region.

20. A wireless access point comprising:
means for storing a region code, wherein the region code identifies a region in which the wireless access point operates;
means for using the region code to identify a one or more wireless channels that are subject to interference within the region; and
means for selecting a wireless channel used by the wireless access point, wherein the wireless channel is selected to avoid the one or more wireless channels that are subject to interference within the region.

21. The wireless access point of claim 20, wherein the means for using the region code to identify a one or more wireless channels that are subject to interference within the region comprise:
means for identifying a one or more cellular radio bands used for wireless communication within the region in response to the region code.

22. The wireless access point of claim 21, wherein the means for using the region code to identify a one or more wireless channels that are subject to interference within the region further comprise:
means for identifying the one or more wireless channels that are subject to interference in response to the one or more cellular radio bands.

23. The wireless access point of claim 20, further comprising means for determining the region code using a global positioning system (GPS) data available to the wireless access point.

24. The wireless access point of claim 23, further comprising means for receiving the GPS data from a GPS receiver of an external wireless device.

25. The wireless access point of claim 23, further comprising means for receiving the GPS data from a GPS receiver of the wireless access point.

26. The wireless access point of claim 20, further comprising means for receiving the region code through a user interface of the wireless access point.

27. The wireless access point of claim 20, wherein the means for using the region code to identify a one or more wireless channels that are subject to interference within the region comprise:
means for storing a cellular band information in the wireless access point, wherein the cellular band information identifies one or more cellular bands used within the region.

28. The wireless access point of claim 27, wherein the means for using the region code to identify a one or more wireless channels that are subject to interference within the region further comprise:
means for storing a wireless channel interference information in the wireless access point, wherein the wireless channel interference information identifies wireless channels that experience interference in response to transmissions in the one or more cellular bands.

29. The wireless access point of claim 20, wherein the region code identifies a country in which the wireless access point operates.

30. The wireless access point of claim 20, wherein the means for using the region code to identify the one or more wireless channels that are subject to interference within the region comprises:
means for identifying a group of wireless channels approved for use within the region in response to the region code.

31. The wireless access point of claim 30, wherein the means for using the region code to identify the one or more wireless channels that are subject to interference within the region further comprises:
means for identifying the one or more wireless channels that are subject to interference within the region in response to the group of wireless channels approved for use within the region.

32. The wireless access point of claim 19, wherein the one or more wireless channels that are subject to interference within the region comprise one or more WiFi channels.
